(19) United States
(12) Patent Application Publication
(10) Pub. No.: US 2025/0005581 A1
(43) Pub. Date: Jan. 2, 2025

(54) NOTIFICATIONS FOR SPLITTING TRANSACTIONS

(71) Applicant: American Express Travel Related Services Company, Inc., New York, NY (US)

(72) Inventors: Ian P. Pulice, Venice, CA (US); Ian T. Moritz, Brooklyn, NY (US); Adam Krochak, New York, NY (US); Swagat Tripathy, Jersey City, NJ (US); Waleed Khan, Manhattan, NY (US); Rahul Singla, Jersey City, NJ (US); William Joseph McCann, Matawan, NJ (US)

(21) Appl. No.: 18/344,210

(22) Filed: Jun. 29, 2023

(51) Int. Cl. G06Q 20/40; G06Q 20/32

(52) U.S. Cl. CPC G06Q 20/405; G06Q 20/3223; G06Q 20/3267; G06Q 20/401

(57) ABSTRACT

Recommended notifications can be sent to mobile devices based at least in part on one or more conditions. The recommended notifications can recommend a user execute a split transaction workflow or a payment plan workflow for a recently charged transaction. In one examples, a system comprises a computing device. The computing device can be configured to identify an authorization of a transaction submitted by a merchant device and determine a context parameter associated with the transaction based at least in part on transaction data. A split classification can be determined for the transaction using a machine learning model based at least in part on the context parameter. A notification can be transmitted to a client device of a user associated with a payment instrument for the transaction based at least in part on the split classification.

### BACKGROUND

During various occasions, a user may pay a bill on behalf of one or more other users. For example, the user may pay for dinner for a group of individuals in order to reduce the amount of time needed for handling the bill. Each individual in the group can desire to pay the user back for their meal. In various mobile applications, each individual can navigate through various user interface for initiating a repayment to the user that paid the bill.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a notification displayed by a client device according to various embodiments of the present disclosure.

FIG. 2 is a drawing of a network environment according to various embodiments of the present disclosure.

FIGS. 3A-3C are pictorial diagrams of example user interfaces displayed by a client device in the network environment of FIG. 2 according to various embodiments of the present disclosure.

FIG. 4A is a flowchart illustrating one example of functionality implemented as portions of a service executed in a computing environment in the network environment of FIG. 2 according to various embodiments of the present disclosure.

FIG. 4B is a flowchart illustrating one example of functionality implemented as portions of a service executed in a computing environment in the network environment of FIG. 2 according to various embodiments of the present disclosure.

FIG. 5 is a flowchart illustrating one example of functionality implemented as portions of an application executed in a client device in the network environment of FIG. 2 according to various embodiments of the present disclosure.

### DETAILED DESCRIPTION

The various embodiments of the present disclosure relate to generating notifications that recommend a user execute a workflow for a recently authorized transaction based at least in part on a context of the recently authorized transaction. For example, various embodiments can send a notification that recommends performing a workflow to split a recent transaction. The split transaction workflow can be performed using a mobile application to split the recent transaction among other users. The split transaction workflow ocan coordinate sending repayment requests to the other users at one or more peer-to-peer mobile payment platforms. Various embodiments can send the notification to the user recommending that the user split a transaction because the various embodiments can predict that the user may be interested in splitting the recent transaction among other users.

In certain situations, a user may incur a charge on behalf of one or more users. For example, a user may pay the bill for dinner for a group of friends. In another example, the user may pay the bill for a house rented by a group of friends during a vacation. In these situations, the user has to remember to ask the other users to pay their share of the expense. In some cases, the user may send repayment requests. In order to send the repayment requests, the user may first have to remember to find the transaction in their credit card or banking application. Then, the user may have to initiate a split transaction workflow for the identified transaction. If the user does not remember to take these actions soon after the transaction has occurred, the user may forget to ask other users to pay their share of the bill.

To address these issues, the various embodiments of the present disclosure can identify recent transactions for a user. The embodiments can predict whether each identified transaction was incurred by the user on behalf of a group of users. The various embodiments can also determine whether the user would likely be interested in splitting the transaction. If it is predicted that the user would likely want to split the transaction, a notification can be transmitted to a mobile device of the user as a recommendation. In addition, the embodiments can be used to predict whether the user may be interested in performing other financial workflows for a recent transaction. For example, instead of a split transaction recommendation, the embodiments can predict whether the user may be interested in creating a payment plan for the recently authorized transaction. As such, the embodiments can transmit a notification to the client device of the user based at least in part on a context of the transaction indicating that the user may be interested in paying for the transaction with a series of payments over time.

The embodiments provide certain improvements from prior approaches in the field of mobile payments. The embodiments improve the user experience by making a financial transaction workflow easier and quicker to complete. First, for example, the user does not have to identify and select a particular transaction for a split transaction workflow. Instead, the various embodiments can recommend that the user may be interested in splitting a transaction. Second, the embodiments provide a process that requires fewer user interactions (e.g., fewer user interface selections) to complete a split transaction workflow, which increases the speed at which the user can accomplish the task. As such, the embodiments reduce the amount of time that is required navigated through various user interfaces for completely workflow, such as a split transaction workflow or a payment plan workflow. Third, the user does not have to remember which transaction to select for a transaction workflow. Instead, the embodiments can identify and present to the user transactions they would likely be interested in executing a split transaction workflow, a payment plan workflow or suitable other transaction workflows.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

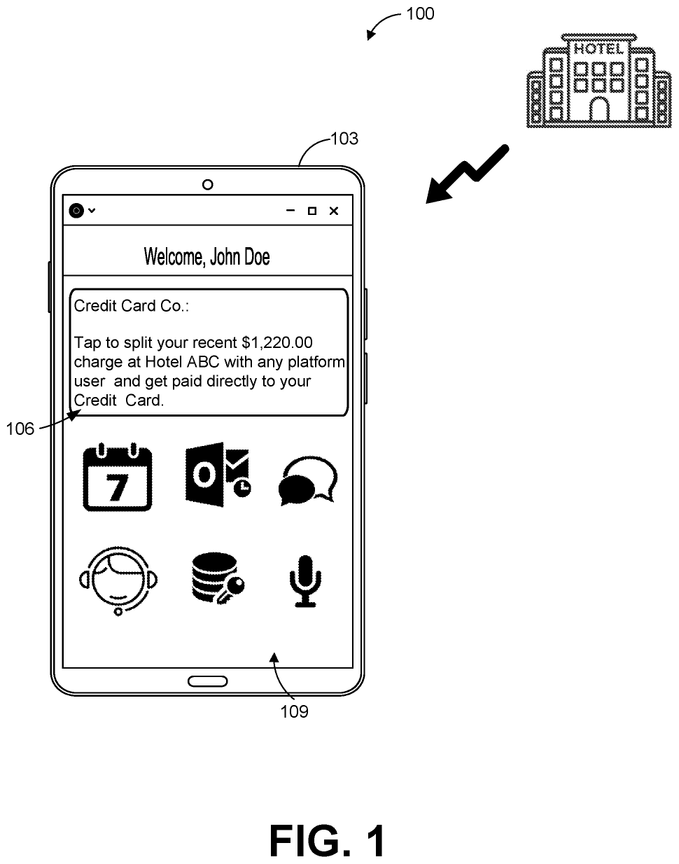

As illustrated in FIG. 1, shown is an example scenario 100 of a client device 103 displaying a split notification 106 superimposed on a user interface 109. In the depicted scenario 100, a user recently paid a hotel bill at Hotel ABC with a payment instrument (e.g., credit card, debit card, charge card, etc.). Since the charge was recently authorized, the charge has a present status as a pending transaction that has been authorized. Typically, after a charge has been authorized as a pending transaction, the merchant receives an authorization code.

In this scenario 100, the pending transaction for the hotel charge is evaluated and determined to likely be splitable with another user based at least in part on various factors. In some instances, a machine learning model can be used to predict whether the hotel charge is likely to be split with at least one other user. For example, the data for the pending transaction may indicate one or more of a number of guests, extra guest fees, and other hotel information. This transaction data, among other possible data, can be used to predict whether to recommend a split transaction workflow to user.

As a result, the split notification 106 can be sent as a push notification to the client device 103 of user (e.g., the account owner) for the payment instrument used for the hotel charge. The split notification 106 can include text to identify the pending transaction that has been authorized for the hotel charge. The text can include the charge amount, merchant information (e.g., merchant identifier/name, location for the transaction, etc.), and other suitable transaction information. The split notification 106 can also include a deep link for activating a split transaction workflow of a mobile application executed in the client device 103.

As such, upon a receiving a “Tap” or a selection of the split notification 106, the deep link for the mobile application can be activated. The deep link can cause the mobile application to be executed and to direct the mobile application to a split transaction user interface. As such, the deep link can direct the mobile application to an advanced stage in the split transaction workflow, which shortens the amount of time used to complete a split transaction workflow. In addition, since the transaction recently occurred, the user can easily decide whether to split the transaction with other users and which users should be included in covering a portion of the hotel charge.

Although FIG. 1 uses the example of splitting the cost of a hotel bill with multiple users, this is purely an illustrative example to highlight an example of an embodiment of the present disclosure. Other types of charges could be split using the same or a similar process or workflow (e.g., a large purchase such as a restaurant bill, a large purchase for multiple tickets to an event, a purchase of multiple airline tickets, etc.) Additionally, other types of workflows could be performed on a recent transaction.

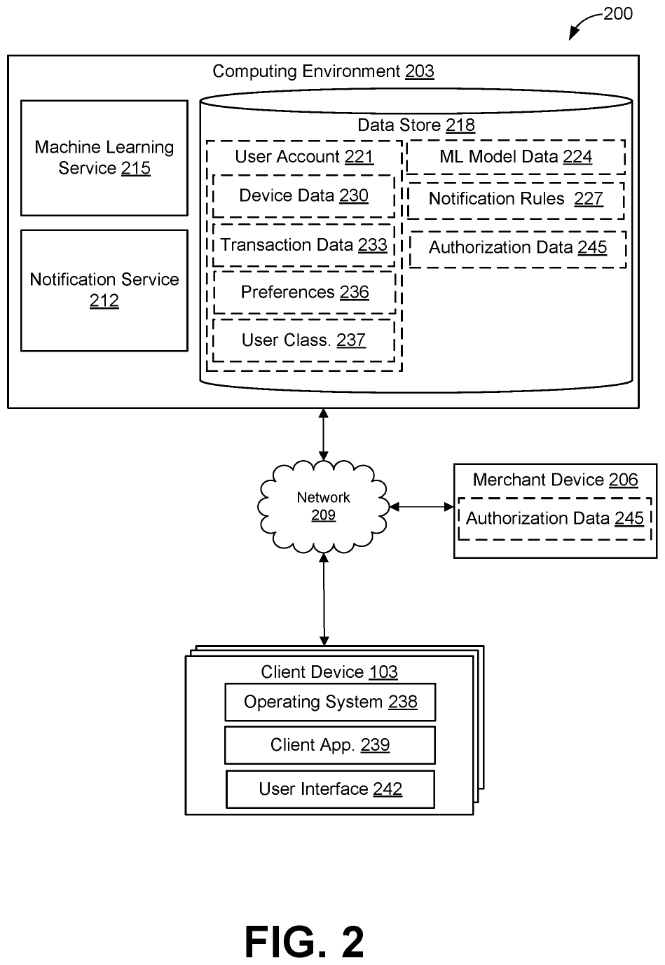

With reference to FIG. 2, shown is a network environment 200 according to various embodiments. The network environment 200 can include a computing environment 203, a client device 103, and a merchant device 206, which can be in data communication with each other via a network 209. The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a notification service 212, a machine learning service 215, and other applications, services, processes, systems, engines, or functionality not discussed in detail herein.

The notification service 212 can be executed to identify recent transactions and determine whether to recommend a split transaction workflow or other suitable transaction workflows available on a mobile application executed on the client device 103. If a split is recommended, then the notification service 212 can transmit a split notification to the client device 103 of the user associated with the transaction.

The machine learning service 215 can be executed to develop, train, test, validate, and deploy machine learning models for predicting whether a recent transaction is likely to be split among multiple users. In another context, the machine learning models can be used to predict whether a particular user for a transaction would be interested in splitting the particular transaction among other users. The machine learning service 215 can be executed to retrain the machine learning models based on feedback data, such as whether prior transactions were split (e.g., splits executed after transmitted split notifications and splits executed without split notification, etc.).

Also, various data is stored in a data store 218 that is accessible to the computing environment 203. The data store 218 can be representative of a plurality of data stores 218, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 218 is associated with the operation of the various applications or functional entities described below. This data can include one or more user accounts 221, machine learning model data 224, notification rules 227, and potentially other data.

Individual user accounts 221 can represent an account or a profile for individual users. Each user account 221 can include a device data 230, transaction data 233, preferences 236, user classification 237, and other suitable data for a respective user. The device data 230 can include data relating to a device operated or owned by a user. For example, the device data 230 can include a device identifier (e.g., an assigned phone number, a device serial number, etc.), a device type, a device operating system, a list of installed applications, and other suitable device data.

The transaction data 233 can represent transaction information relating to pending transactions (e.g., recent transaction), posted transaction, and/or other suitable transaction data. For example, the transaction data 233 can include information such as a transaction amount, a transaction type (e.g., online, magnetic stripe, Europay Mastercard and Visa (EMV) security chip, etc.), a transaction location, a payment instrument identifier (e.g., a credit card number, a financial account, etc.), merchant data, a purchase category (e.g., hotel/accommodation, dining, grocery, gas, etc.), and/or other suitable transaction information. The merchant data can include a merchant identifier, transaction context, and/or other suitable data. The transaction context can provide information relating to what goods and services were purchased.

The preferences 236 can represent one or more preferences or criteria specified by the user regarding split notifications. The preferences 236 can include a whether the user has decided to participate in the split notifications. The preferences 236 can also include characteristics of transactions that the user may be interested in splitting. For instance, the preferences 236 can include a minimum purchase threshold, a purchase category (e.g., lodging charges, dining charges), a time period (e.g., specified time period for a business trip, transactions during a weekday), and/or other suitable preferences 236.

The user classification 237 can be used to represent the spending ability of the user and/or their previous history with splitting transactions. Some example user classifications 237 can include active split users, business users, dormant split users, inactive split users, and other suitable classification. In some examples, the notification service 212 can determine the user classification 237 based at least in part on one or more factors, such as access to financial resources (e.g., employment, assets, etc.), history with executing split transactions, and/or other suitable historical information. In some examples, the notification service 212 can transmit split notifications to users that are classified as dormant split users or inactive split users because these users may be unaware of this feature for a mobile application.

The machine learning model data 224 can represent data used by machine learning models, such as feedback data, training data sets, and/or other suitable machine learning data. For example, the machine learning model data 224 can include data that relates to which features (e.g., variables) are selected for optimizing machine learning models for predicting split transaction events or other suitable transaction workflow events. A machine learning model can be a file that is generated from executing a machine learning algorithm based at least in part on a training data set. Each machine learning model can include rules, patterns, values, and/or other aspects related to making a prediction. The machine learning models can be generated using one or more classification algorithms, such as decision tree, linear regression, logistic regression, artificial neural network, k-nearest neighbors, k-means, and other suitable machine learning algorithms.

The notification rules 227 can represent one or more rules for determining whether to transmit a notification to a client device 103. For example, although the notification service 212 may determine to send a split notification, a notification rule 227 can specify whether it is permissible to send the split notification at the present time. The notification rules 227 can be configured to send notifications at appropriate times in order to not annoy the user or alternatively, at a time where the user may be more likely to review and select the notification. For example, the notification rules 227 can have time windows that correspond to historical trends of when a particular user is more likely to at least review notification and possibly select the notification.

The client device 103 is representative of a plurality of client devices that can be coupled to the network 209. The client device 103 can include a processor-based system such as a computer system embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, set-top boxes, and similar devices), a videogame console, or other devices with like capability. The client device 103 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 103 or can be connected to the client device 103 through a wired or wireless connection.

The client device 103 can be configured to execute various applications such as an operating system 238, a client application 239, or other applications. The operating system 238 can be executed to manage computing hardware and software resources. The operating system 238 can be executed to display one or more user interfaces 242 and to cause the execution of the client application 239. The operating system 238 can be executed to display notifications (e.g., split notification, payment plan notifications). The notifications can be triggered based at least in part on communication from the notification service 212 and/or the client application 239.

The client application 239 can be executed to facilitate functionality associated with the notification service 212. The client application 239 can be executed in a client device 103 to access network content served up by the computing environment 203 or other servers, thereby rendering a user interface 242 on the display. In some examples, the client application 239 can display user interfaces 242 for the notification service 212. Upon a notification being selected on the user interface 242, the client application 239 can be activated to display a particular user interface 242 in an advanced stage of a split transaction workflow, a payment plan workflow, or other suitable transaction workflows associated with the client application 239.

Additionally, the client application 239 can include a browser, a dedicated application, or other executable, and the user interface 242 can include a network page, an application screen, or other user mechanism for obtaining user input. The client device 103 can be configured to execute applications beyond the client application 239 such as email applications, social networking applications, word processors, spreadsheets, or other applications.

The merchant device 206 can represent one or more devices of a payment environment for a merchant. As such, the merchant device 206 can include point-of-sale (POS) devices (e.g., online and at retail locations), merchant servers (e.g., servers for hosting website and payment processing functionality), and/or other suitable or similar devices. The merchant devices 206, such as a PoS device, can accept payment instruments from a user in order to complete a purchase of an item or service. The merchant devices 206 can store authorization data 245 received from the notification service 212. The authorization data 245 can comprise pending transactions, posted transactions, and/or other suitable transactions. The pending transactions may have an authorization code that indicates a transaction has been authorized. For example, after the authorization data 245 has been generated for the merchant device 206, then the notification services 212 can identify the pending transaction for evaluation for a split notification.

Next, a general description of the operation of the various components of the network environment 200 is provided. To begin, a user of the client device 103 can agree to participate in receiving split notifications 106 for transactions completed with their payment instrument. In some embodiments, the notification service 212 can assess a user account 221 for the user in order to determine some initial context parameters. For example, the notification service 212 can determine a user classification 237 for the user based at least in part on the transaction history, split transaction history, historical transaction types (e.g., business transactions or personal transactions), type of payment instrument (e.g., business credit card, personal credit card), and/or other suitable data.

Afterwards, the user can complete a purchase with his or her payment instrument. The notification service 212 can determine whether to send a split notification 106 to the client device 103 of the user based at least in part on one or more factors. In some examples, the notification service 212 can use a trained machine learning model to predict whether the user would desire to use the split transaction workflow of the client application 239 for the purchase. In some scenarios, the machine learning model can predict the likelihood of the user using split transaction workflow based at least in part on one or more factors indicating that the transaction was made on behalf of at least one other user and the user would be interested in requesting repayment of at least a portion of the purchase from the other user.

For example, the machine learning model may predict that the user would likely be interested in a split transaction workflow because the transaction occurred at restaurant and the transaction amount was higher than the typical amount for a single individual at the restaurant. For example, the transaction amount may be compared to an average amount for an entree menu item of a restaurant of a certain tier, an average amount for an entree menu item at the restaurant, or in comparison for other suitable restaurant data. In addition, the machine learning model may also factor in calendar data for the user. The calendar data for the user can indicate the user had a meeting around a breakfast time period, a lunch time period, or a dinner time period.

Accordingly, the notification service 212 can transmit a split notification 106 to the client device 103 of the user. Upon the selection of the split notification 106, the operating system 238 can activate a deep link for executing the client application 239. The deep link activation can direct the client application 239 to an advanced state in the client application 239 for a split transaction workflow. As previously discussed, this allows a user to skip one or more steps in the typical client-side split transaction workflow because of the selection of the split notification 106.

In some examples, the machine learning models can be trained based at least in part on feedback data and preferences 236 provided by the user. As such, a deployed machine learning model can be optimized for an individual user or a group of individuals with similar preferences 236.

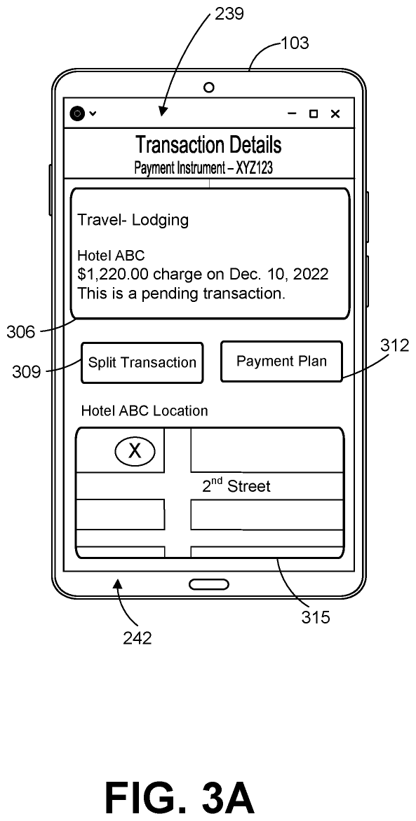

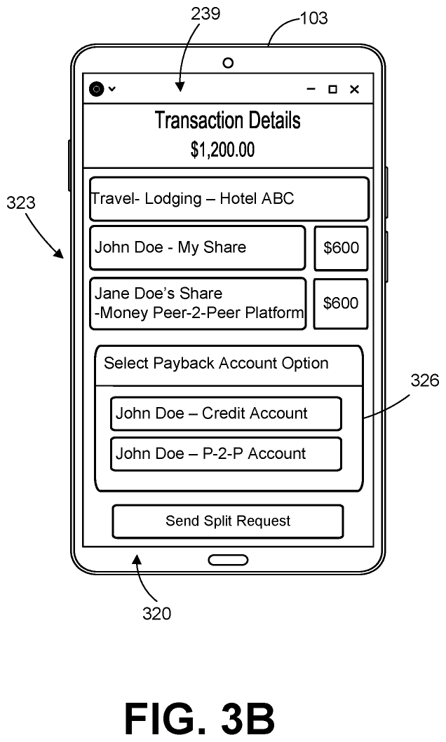

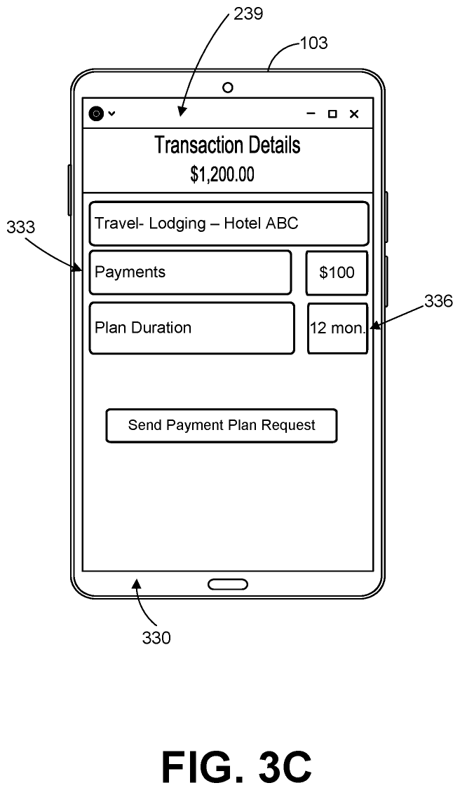

Turning now to FIG. 3A, shown is an example of a user interface 242 that is configured for a user to select activating a transaction workflow (e.g., a split transaction workflow or a payment plan workflow). The user interface 242 is one example that can be displayed on the client device 103. In FIG. 3A, the user interface 242 can be displayed in response to an activation of a deep link associated with the split notification 106 or other notifications for suggesting another workflow associated with the client application 239. The activation of the deep link causes the operating system 238 to execute the client application 239 and to display the user interface 242 at an advanced stage of the transaction workflow.

The user interface 242 can represent one or more user interfaces for receiving data for a split request of a selected transaction or for receiving data for a payment plan request of the selected transaction. The user interfaces 242 can display transaction data 233 associated with the selected transaction in a transaction portion 306 of the user interface 242. The transaction data 233 can include a transaction amount, a merchant identifier, a transaction date, a transaction status (e.g., pending or posted transaction), a transaction location, and other suitable information.

The user interface 242 can include a user interface elements for display, such as a split user interface element 309, a plan user interface element 312, and other suitable user interface elements. The user interface 242 can include a map 315 that indicates the transaction location. The split user interface element 309 can be configured to display one or split user interfaces for executing a split transaction workflow. The plan user interface element 312 can be configured to display one or more payment plan user interfaces for executing a payment plan workflow.

FIG. 3B illustrates an example of a split user interface 320 for a user to provide data for executing a split transaction workflow. In some examples, the split user interface 320 can be displayed by the client application 239 in response to a selection of the split user interface element 309 in the user interface 242. In other examples, the split user interface 320 can be displayed in response to activating the deep link associated with the split notification 106. Additionally, the content shown in the split user interface 320 can be displayed in one or more user interfaces.

As shown, the split user interface 320 can include a requestee area 323 and a payback area 326. The requestee area 323 can include a selected requestee (e.g., Jane Done) and a portion amount of the transaction amount. The requestee area 323 can configured to receive a selection or entry of the requestee and an entry of the portion amount. The selected requestee include a selected account of the requestee to request repayment. For instance, the requestee area 323 indicates that Jane Doe's “Money Peer-2-Peer Platform” account has been selected.

The payback area 326 can represent an area for selecting an account of the user for depositing repayment funds received from the requestees. The payback area 326 can include a first option for a credit account of John Doe and a second option for a peer-to-peer account of John Doe. The payback area 326 can receive a selection of one of the options.

FIG. 3C illustrates an example of a plan user interface 330 for a user to provide data for executing a payment plan workflow of the client application 239. In some examples, the plan user interface 330 can be displayed by the client application 239 in response to a selection of the plan user interface element 312. In other examples, the plan user interface element 312 can be displayed in response to activating the deep link associated with a notification displayed by the operating system 238.

The plan user interface 330 can include a payment area 333 and a plan duration area 336. The payment area 33 can be configured for the user to set a payment amount (e.g., $100) and the plan duration area 336 can be configured for the user to set a time period for the plan (e.g., 12 months).

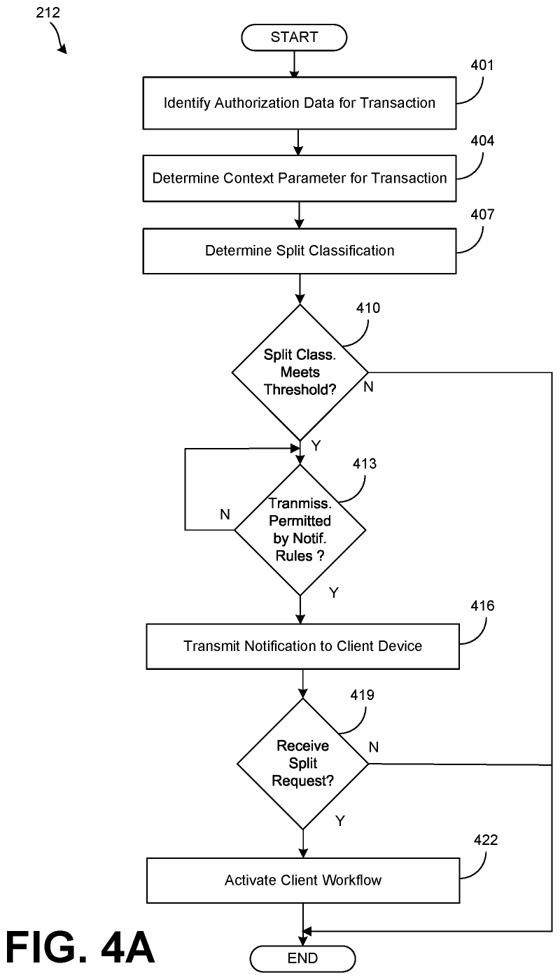

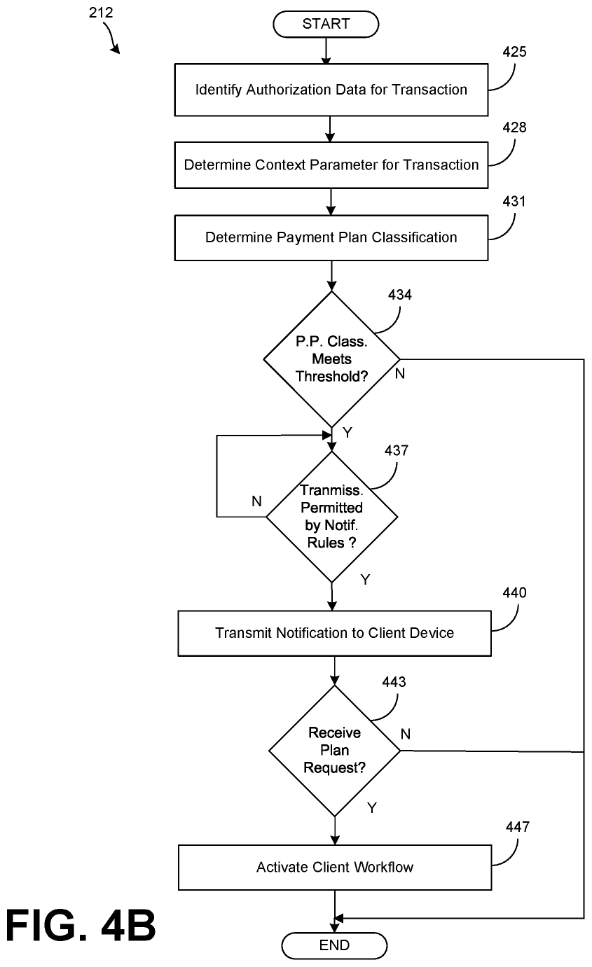

Referring next to FIG. 4A, shown is a flowchart that provides one example of the operation of a split workflow of the notification service 212. The flowchart of FIG. 4A provides merely an example of the many different types of functional arrangements that can be employed to implement the operation of the depicted portion of the notification service 212. As an alternative, the flowchart of FIG. 4A can be viewed as depicting an example of elements of a method implemented within the network environment 200.

Beginning with box 401, the notification service 212 can identify authorization data 245 for a recent transaction. In some examples, the authorization data 245 can be generated by the notification service 212 after receiving an authorization request for a transaction from a merchant device 206. After the transaction has been approved as a pending transaction, authorization data 245 can be generated for the transaction and the authorization data 245 can be transmitted to the merchant device 206. In some examples, the authorization data 245 can include an authorization code.

In box 404, the notification service 212 can determine one or more context parameters for the pending transaction. The context parameters can be identified from the transaction data 233 and/or the authorization data 245, such as a transaction amount, a merchant identifier, a purchase category (e.g., lodging, grocery, retail, travel, entertainment, dining, etc.), a transaction date, a transaction location, and other suitable. In addition, the context parameters can include historical transaction data, such as previous transaction splits, previous spending patterns, and other historical transaction activity.

In some embodiments, the notification service 212 can determine a user classification 237 of the user as a context parameter. The user classification 237 can represent a classification of the user associated with the payment instrument used for the pending transaction. For example, the user classification 237 can be used to represent the spending ability of the user and/or their previous history with splitting transactions. Some example user classifications 237 can include active split users, business users, dormant split users, inactive split users, and other suitable classification. In some examples, the notification service 212 can determine the user classification 237 based at least in part on one or more factors, such as access to financial resources (e.g., employment, assets, etc.), history with executing split transactions, and other suitable historical information. In some embodiments, the notification service 212 can use the user classification 237 to determine the split classification for the pending transaction and/or subsequent actions to be taken for the user associated with the pending transaction.

In box 407, the notification service 212 can determine a split classification for the pending transaction based at least in part on the one or more context parameters. The split classification can be a numerical value or a classification type (e.g., low split likelihood, medium split likelihood, high split likelihood). In some implementations, the notification service 212 can use a machine learning model for predicting a split classification for the pending transaction. In some examples, the split classification can represent a likelihood of the pending transaction being split with at least one other user or the split classification can be used to encourage the user to perform more split transactions.

In some examples, the split classification can be represented as numerical value for the likelihood of the user to split the pending transaction. In this example, the split classification can be a value generated by a machine learning model based at least in part on one or more inputs. If the value meets a value threshold, then the notification service 212 can generate a split notification recommendation at box 410.

In some examples, the split classification can be based at least in part on the user classification 237. For example, users classified as dormant users or active split users can be classified having a medium likelihood or a high split likelihood in order to encourage the user to use a split transaction workflow for the client application 239.

In box 410, the notification service 212 can determine whether the split classification meets a threshold. The threshold can be numerical value, a classification type, a combination of different data type, and other suitable threshold for comparison. For example, the threshold can be a numerical value for comparing against a numerical value of the split classification. In other examples, the threshold can represent a minimum classification, such as the split classification has to be at least a medium split likelihood. If the split classification meets the threshold, then the notification service 212 can proceed to box 413. If the split classification does not meet a threshold, then the notification service 212 can proceed to the end.

In box 413, the notification service 212 can determine whether the notification rules 227 permit the split notification to be sent to the client device 103. The notification rules 227 can be implemented to prevent overwhelming a user with notifications. For example, a notification rule 227 can be if a user does not open at least one of a set of split notifications, then the notification service 212 can pause or temporarily disable split notifications from being transmitted for a time period of thirty days.

Another notification rule 227 can include disabling split notifications after three cycles of a sending a set of split notifications and implementing a pause period of time (e.g., thirty days). In this example, disabling notifications may require an administrator user to enable notifications for subsequent notifications.

Another example of a notification rule 227 can be configured to deny sending a notification if the operating system 238 of the client device 103 or other mobile applications have sent a prior notification within a time period. If transmission of the notification is permitted by the one or more notification rules 227, the notification service 212 can proceed to box 416. If transmission of the notification is not permitted by the one or more notification rules 227, the notification service 212 can proceed to back to box 413.

In box 416, the notification service 212 can transmit a split notification or other notifications to the client device 103. The notification service 212 can identify a client device 103 of the user of the payment instrument for the pending transaction. The device data 230 can include a device identifier that can be used for routing the notification to the client device 103. The notification can be a push notification, a short message service (e.g., a text message), and other suitable notification techniques for client devices 103. The notification can have a deep link for directing the client application 239 to an advanced state in a split transaction workflow. As such, the client application 239 can display a user interface 242 or an alternative user interface (e.g., a split user interface 320).

Accordingly, if the user selects the notification, the operating system 238 can execute the client application 239 to display the user interfaces 242. The user interface 242 can represent an advanced stage of a split transaction workflow. In some examples, the user interfaces 242 can be displayed to collect data for preparing a split request associated with the split transaction workflow.

In other examples, the user interface 242 can include a split user interface element 309. If the split user interface element 309 has been selected, one or more split user interfaces 320 can be displayed and used to collect one or more of the following: the selected transaction, an amount portion of the selected transaction, a selected requestee, a requestor financial account (e.g., user sending the payment request) for depositing the repayment funds, a peer-to-peer platform account for the requestee, and other suitable data. After the data has been collected from the split user interfaces 320, then the operating system 238 and/or the client application 239 can transmit a split request that includes the collected data for completing split transaction workflow in the computing environment 203.

In some examples, the notification service 212 can determine whether the split notification has been selected. If the split notification is not selected, the notification service 212 can proceed to the end. In some examples, the operating system 238 can indicate whether the split notification has been selected within a threshold time period from displaying the notification on the client device 103.

In some embodiments, if the split notification is selected, the notification service 212 can direct the operating system 238 to display the user interface 242. The user interface 242 can be displayed for identifying a selection of a client workflow via a user interface element (e.g., via a split user interface element 309), such as a split transaction workflow. The split user interface 320 can be displayed to collect input data from the user. The collected input data can be used for transmitting a split request to the computing environment.

In box 419, the notification service 212 can determine whether a split request has been received from the client device 103. If the split request has been received then, the notification service 212 can proceed to box 422. If the split request has not been received then, the notification service 212 can proceed to the end.

In box 422, the notification service 212 can activate a split transaction workflow based at least in part on the split request received from the client device 103. The split request can include a requestee, a selected transaction, a requestee, and other suitable data. The split transaction workflow can represent a process for splitting a transaction by requesting repayment for a portion of the selection transaction from selected requestees. The repayment request can be transmitted via one or more peer-to-peer payment platforms (e.g., Venmo®, Cashapp®, Zelle®, Paypal®, etc.). Then, the notification service 212 can proceed to the end.

Referring next to FIG. 4B, shown is a flowchart that provides one example of the operation of a payment plan workflow of the notification service 212. The flowchart of FIG. 4B provides merely an example of the many different types of functional arrangements that can be employed to implement the operation of the depicted portion of the notification service 212. As an alternative, the flowchart of FIG. 4B can be viewed as depicting an example of elements of a method implemented within the network environment 200.

Beginning with box 425, the notification service 212 can identify authorization data 245 for a recent transaction. In some examples, the authorization data 245 can be generated by the notification service 212 after receiving an authorization request for a transaction from a merchant device 206. After the transaction has been approved as a pending transaction, authorization data 245 can be generated for the transaction and the authorization data 245 can be transmitted to the merchant device 206. In some examples, the authorization data 245 can include an authorization code.

In box 428, the notification service 212 can determine one or more context parameters for the pending transaction. The context parameters can be identified from the transaction data 233 and/or the authorization data 245, such as a transaction amount, a merchant identifier, a purchase category (e.g., lodging, grocery, retail, travel, entertainment, dining, etc.), a transaction date, a transaction location, and other suitable. In addition, the context parameters can include historical transaction data, such as previous transaction splits, previous spending patterns, and other historical transaction activity.

In some embodiments, the notification service 212 can determine a user classification 237 of the user as a context parameter. The user classification 237 can represent a classification of the user associated with the payment instrument used for the pending transaction. For example, the user classification 237 can be used to represent the spending ability of the user and/or their previous history with setting up payment plans for transactions. Some example user classifications 237 can include active payment plans users, business users, dormant payment plans users, inactive payment plan users, and other suitable classification. In some examples, the notification service 212 can determine the user classification 237 based at least in part on one or more factors, such as access to financial resources (e.g., employment, assets, etc.), history with setting up payment plans for transactions, and other suitable historical information. In some embodiments, the notification service 212 can use the user classification 237 to determine the transaction classification for the pending transaction and/or subsequent actions to be taken for the user associated with the pending transaction.

In box 431, the notification service 212 can determine a payment plan classification for the pending transaction based at least in part on the one or more context parameters. The transaction classification can be a numerical value or a classification type (e.g., low payment plan likelihood, medium payment plan likelihood, high payment plan likelihood). In some implementations, the notification service 212 can use a machine learning model for predicting a payment plan classification for the pending transaction. In some examples, the payment plan classification can represent a likelihood of the pending transaction being paid with a payment plan or the payment plan classification can be used to encourage the user to set up more payment plan of his/her transactions.

In some examples, the payment plan classification can be represented as numerical value for the likelihood of the user to set up a payment plan for the pending transaction. In this example, the payment plan classification can be a value generated by a machine learning model based at least in part on one or more inputs. If the value meets a value threshold, then the notification service 212 can generate a payment plan notification recommendation at box 434.

In box 434, the notification service 212 can determine whether the payment plan classification meets a threshold. The threshold can be numerical value, a classification type, a combination of different data type, and other suitable threshold for comparison. For example, the threshold can be a numerical value for comparing against a numerical value of the payment plan classification. In other examples, the threshold can represent a minimum classification, such as the split classification has to be at least a medium likelihood. If the payment plan classification meets the threshold, then the notification service 212 can proceed to box 437. If the payment plan classification does not meet a threshold, then the notification service 212 can proceed to the end.

In box 437, the notification service 212 can determine whether the notification rules 227 permit a payment plan notification to be sent to the client device 103. The notification rules 227 can be implemented to prevent overwhelming a user with notifications. For example, a notification rule 227 can be if a user does not open at least one of a set of notifications, then the notification service 212 can pause or temporarily disable notifications from being transmitted for a time period of thirty days.

Another notification rule 227 can include disabling notifications after three cycles of a sending a set of notifications and implementing a pause period of time (e.g., thirty days). In this example, disabling notifications may require an administrator user to enable notifications for subsequent notifications.

Another example of a notification rule 227 can be configured to deny sending a notification if the operating system 238 of the client device 103 or other mobile applications have sent a prior notification within a time period. If transmission of the notification is permitted by the one or more notification rules 227, the notification service 212 can proceed to box 416. If transmission of the notification is not permitted by the one or more notification rules 227, the notification service 212 can proceed to back to box 440.

In box 440, the notification service 212 can transmit a payment plan notification to the client device 103. The notification service 212 can identify a client device 103 of the user of the payment instrument for the pending transaction. The device data 230 can include a device identifier that can be used for routing the payment plan notification to the client device 103. The payment plan notification can be a push notification, a short message service (e.g., a text message), and other suitable notification techniques for client devices 103. The payment plan notification can have a deep link for directing the client application 239 to an advanced state in a payment plan workflow. As such, the client application 239 can display a user interface 242 or an alternative user interface 242 (e.g., a plan user interface 330).

Accordingly, if the user selects the payment plan notification, the operating system 238 can execute the client application 239 to display the user interfaces 242. The user interface 242 can represent an advanced stage of a payment plan workflow. In some examples, the user interfaces 242 can be displayed to collect data for preparing a payment plan request associated with the payment plan workflow.

In other examples, the user interface 242 can include a split user interface element 309 and/or a plan user interface element 312. If the plan user interface element 312 has been selected, one or more plan user interfaces 330 can be displayed and used to collected one or more of the following: a payment amount, a payment time period for receiving each payment amount, and other suitable payment plan conditions. After the data has been collected from the plan user interfaces 330, then the operating system 238 and/or the client application 239 can transmit a plan request that includes the collected data for perform a server-side payment plan workflow.

In some examples, the notification service 212 can determine whether the notification has been selected. If the notification is not selected, the notification service 212 can proceed to the end. In some examples, the operating system 238 can indicate whether the notification has been selected within a threshold time period from displaying the notification on the client device 103.

In some embodiments, if the notification is selected, the notification service 212 can direct the operating system 238 to display the user interface 242. The user interface 242 can be displayed for identifying a selection of a client workflow via a user interface element (e.g., via a split user interface element 309), such as a payment plan workflow. The plan user interface 330 can be displayed to collect input data from the user. The collected input data can be used for transmitting a payment plan request.

In box 443, the notification service 212 can determine whether a payment plan request has been received from the client device 103. If the payment plan request has been received then, the notification service 212 can proceed to box 447. If the payment plan request has not been received then, the notification service 212 can proceed to the end.

In box 447, the notification service 212 can activate a payment plan workflow based at least in part on the plan request being received from the client device 103. The plan request can include a payment amount, a plan time period for the payment amount, and other suitable payment plan conditions. The payment plan workflow can represent a process for creating a payment plan of a number of payments over a period of time for the selected transaction. Then, the notification service 212 can proceed to the end.

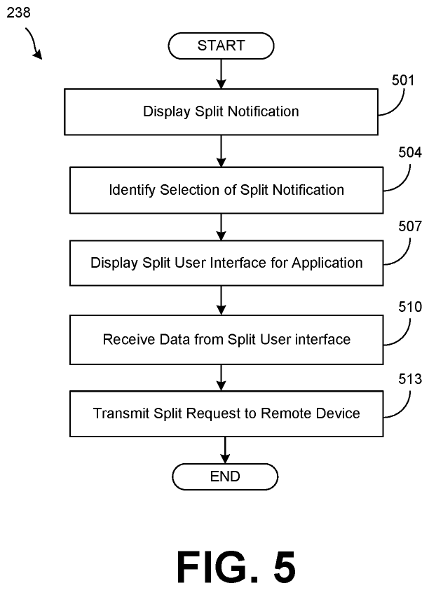

Referring next to FIG. 5, shown is a flowchart that provides one example of the operation of a portion of the client application 239. The flowchart of FIG. 5 provides merely an example of the many different types of functional arrangements that can be employed to implement the operation of the depicted portion of the client application 239. As an alternative, the flowchart of FIG. 5 can be viewed as depicting an example of elements of a method implemented within the network environment 200.

Beginning with box 501, the operating system 238 can display a split notification received 106 received from the notification service 212. The split notification 106 can be transmitted by the notification service 212. In some examples, the split notification 106 may be played via a speaker of the client device 103 using a voice synthesizer. The split notification 106 can include one or more components such as a transaction identifier, a merchant identifier, a financial service provider identifier, and other suitable information. The split notification 106 can be associated with a deep link for the client application 239. The deep link can activate the client application 239 to an advance stage of a client split transaction workflow. The deep link can represent a link for specific webpage using a Hypertext Transfer Protocol (HTTP) uniform resource locator (URL) or the deep link can represent a mobile deep link for directly linking to in-application content using non-HTTP uniform resource identifier (URI).

In box 504, the operating system 238 can identify a selection of the split notification 106. The selection of the split notification 106 can activate the deep link to the client application 239. The selection of the split notification 106 can cause the operating system 238 to execute the client application 239. In some embodiments, the selection causes the operating system 238 to provide the client application 239 data associated with the split notification 106 for the advance stage of the client split transaction workflow. For example, the operating system 238 can provide one or more elements such as, a notification identifier, a transaction identifier, a transaction amount, an application reference for displaying the split user interface 303, and other suitable data. As such, the operating system 238 can activate the client application 239 and direct the client application 239 display the split user interface 303 based at least in part on the selection of the split notification 106.

In box 507, the operating system 238 can display a split user interface 303 on the client device 103. The split user interface 303 can represent one or more user interfaces for receiving data for a split request of a selected transaction. The split user interfaces 303 can display transaction data 233 associated with the selected transaction. The transaction data 233 can include a transaction amount, a merchant identifier, a transaction date, a transaction status (e.g., pending or posted transaction), a transaction location, and other suitable information.

The user interface 242 can include a user interface elements for display, such as a split user interface element 309, a plan user interface element 312, and other suitable user interface elements. The user interface 242 can include a map 315 that indicates the transaction location.

In box 510, the operating system 238 can receive data from the split user interface 303. The data received from the split user interface 303 can include one or more data elements, such as selected requestees, a portion amount of the transaction, a selected peer-to-peer payment platform account for the selected requestee, a selected payment instrument for depositing the repayment funds, and other suitable data.

In box 513, the operating system 238 can transmit a split request to the notification service 212 in the computing environment 203. The split request can include data received from the split user interfaces 303. Then, the client application 239 can proceed to the end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4 and 5 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 4 and 5 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 4 and 5 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
identify an authorization of a transaction submitted by a merchant device;
determine a context parameter associated with the transaction based at least in part on transaction data;
determine a split classification for the transaction using a machine learning model based at least in part on the context parameter; and
transmit a notification to a client device of a user associated with a payment instrument for the transaction based at least in part on the split classification.

2. The system of claim 1, wherein the notification is transmitted based at least in part on the split classification meeting a classification threshold.

3. The system of claim 1, wherein the machine-readable instructions further cause the computing device to at least:
determine a notification context for the client device based at least in part on identify a quantity of prior notifications sent to the client device for a period of time.

4. The system of claim 3, wherein the notification context comprises an indication that the quantity of prior notifications have not been activated on the client device.

5. The system of claim 3, wherein the notification is transmitted based at least in part on the notification context meeting a notification rule.

6. The system of claim 1, wherein the machine-readable instructions further cause the computing device to at least:
receive a split request for the transaction from the client device, the split request comprising a requestee and an amount portion of the transaction; and
execute a split workflow based at least in part on the requestee and the amount portion for the transaction.

7. The system of claim 1, wherein the context parameter comprises at least one of a previous split instance associated with a user account, a transaction type, a merchant identifier, a transaction amount, or a type of payment instrument.

8. A method, comprising:
identifying, by a computing device, an authorization of a transaction submitted by a merchant device;
determining, by the computing device, a context parameter associated with the transaction based at least in part on transaction data;
determining, by the computing device, a split classification for the transaction using a machine learning model based at least in part on the context parameter; and
transmitting, by the computing device, a notification to a client device of a user associated with a payment instrument for the transaction based at least in part on the split classification.

9. The method of claim 8, wherein the notification is transmitted based at least in part on the split classification meeting a classification threshold.

10. The method of claim 8, further comprising:
determining, by the computing device, a notification context for the client device based at least in part on identify a quantity of prior notifications sent to the client device for a period of time.

11. The method of claim 10, wherein the notification context comprises an indication that the quantity of prior notifications have not been activated on the client device.

12. The method of claim 10, wherein the notification is transmitted based at least in part on the notification context meeting a notification rule.

13. The method of claim 8, further comprising:
receiving, by the computing device, a split request for the transaction from the client device, the split request comprising a requestee and an amount portion of the transaction; and
executing, by the computing device, a split workflow based at least in part on the requestee and the amount portion for the transaction.

14. The method of claim 8, wherein the context parameter comprises at least one of a previous split instance associated with a user account, a transaction type, a merchant identifier, a transaction amount, or a type of payment instrument.

15. A system, comprising:
a computing device comprising a processor and memory;
machine-readable instructions stored in the memory that, when executed by the processor, cause the computing device to at least:
receive a split notification for a transaction from a remote computing device;
display the split notification in a user interface;
identify a selection of the split notification from the user interface;
display a split user interface for the transaction in a mobile application based at least in part on the selection of the split notification, the split user interface comprising a user interface element for activating a split transaction workflow.

16. The system of claim 15, wherein the split user interface is displayed by activating a deep link to the mobile application with respect to the transaction for the split notification.

17. The system of claim 15, wherein the machine-readable instructions, when executed by the processor, further cause the computing device to at least:
identify a selection of the user interface; and
activate the split transaction workflow for the transaction.

18. The system of claim 15, wherein the split notification is a push notification.

19. The system of claim 15, wherein the split user interface comprises a transaction location on a map.

20. The system of claim 15, wherein the split user interface comprises a payment instrument identifier.
